(19) United States
(12) Patent Application Publication
(10) Pub. No.: US 2025/0370264 A1
(43) Pub. Date: Dec. 4, 2025

(54) Displays with Integrated Light Sources

(71) Applicant: Apple Inc., Cupertino, CA (US)

(72) Inventors: Andrew N Leopold, San Francisco, CA (US); Brian S Lau, Seattle, WA (US); Cheng Chen, Saratoga, CA (US); Depeng Wang, San Jose, CA (US); Hong Luo, San Jose, CA (US); Richard G Huizar, San Diego, CA (US)

(21) Appl. No.: 19/175,695

(22) Filed: Apr. 10, 2025

Related U.S. Application Data
(60) Provisional application No. 63/655,863, filed on Jun. 4, 2024.

(51) Int. Cl. G02B 27/01

(52) U.S. Cl. CPC G02B 27/0172; G02B 27/0179; G02B 2027/0178; G02B 2027/0187

(57) ABSTRACT

A head-mounted display may include a transparent region through which a real-world environment is viewable from an eye box. The head-mounted display may include a projector that produces display light and a waveguide that provides the display light and real-world light from the environment to the eye box. A tint layer or other light modulator layer may overlap the waveguide and may be used to adjust at least one of intensity and color of real-world light that is transmitted through the tint layer. One or more gaze tracking light-emitting diodes and/or other light sources may be interposed between the waveguide and the tint layer and may be located within the transparent region of the head-mounted display. The light sources may be mounted to a transparent substrate that is laminated between the waveguide and the tint layer, or the light sources may be mounted to the tint layer.

This application claims the benefit of U.S. provisional patent application No. 63/655,863, filed Jun. 4, 2024, which is hereby incorporated by reference herein in its entirety.

### FIELD

This relates generally to electronic devices and, more particularly, to electronic devices such as head-mounted devices.

### BACKGROUND

Electronic devices such as head-mounted devices sometimes include displays and gaze tracking circuitry. It can be challenging to incorporate gaze tracking circuitry into a head-mounted device. In conventional head-mounted devices, gaze tracking circuitry is mounted in locations that are too far from the pupil and that add bulkiness to the device.

### SUMMARY

A head-mounted device may include left and right displays. For example, a left display may produce a left image for a left eye box. A right display may produce a right image for a right eye box. In some arrangements, a left display may include a left projector and a left waveguide, and a right display may include a right projector and a right waveguide.

A head-mounted display may include a transparent region through which a real-world environment is viewable from an eye box. The head-mounted display may include a projector that produces display light and a waveguide that provides the display light and real-world light from the environment to the eye box. An active tint layer or other light modulator layer may overlap the waveguide and may be used to adjust at least one of an intensity and color of real-world light that is transmitted through the active tint layer. One or more gaze tracking light-emitting diodes and/or other light sources may be interposed between the waveguide and the tint layer and may be located within the transparent region of the head-mounted display. The light sources may be mounted to a transparent substrate that is laminated between the waveguide and the tint layer, or the light sources may be mounted to the tint layer.

### BRIEF DESCRIPTION OF THE DRAWINGS

FIG. 1 is a schematic diagram of an illustrative head-mounted device having a display with one or more integrated light sources in accordance with some embodiments.

FIG. 2 is a top view of an illustrative head-mounted device having a display with one or more integrated light sources in accordance with some embodiments.

FIG. 3 is a diagram of illustrative gaze tracking circuitry that may be included in a head-mounted device in accordance with some embodiments.

FIG. 4 is a side view of an illustrative head-mounted display having a transparent region with one or more integrated light sources in accordance with some embodiments.

FIG. 5 is a side view of an illustrative head-mounted display having a waveguide and a light modulator layer in accordance with some embodiments.

FIG. 6 is a side view of an illustrative head-mounted display having a waveguide, a light modulator layer, and one or more light sources on a substrate in accordance with some embodiments.

FIG. 7 is an exploded perspective view of the head-mounted display of FIG. 6 in accordance with some embodiments.

FIG. 8 is a side view of an illustrative head-mounted display having a waveguide, a light modulator layer, and one or more light sources on the light modulator layer in accordance with some embodiments.

FIG. 9 is an exploded perspective view of the head-mounted display of FIG. 8 in accordance with some embodiments.

### DETAILED DESCRIPTION

An electronic device such as a head-mounted device or other display system may have a transparent display. The transparent display may be formed from a transparent display panel or a non-transparent display panel that provides images to a user through an optical coupler such as a waveguide. A user may view real-world objects through the transparent display while control circuitry directs the transparent display to display computer-generated content over selected portions of the real-world objects. The head-mounted display may have adjustable components such as an adjustable tint layer or other light modulator layer that overlaps the transparent display. The user may view the real-world objects through the waveguide and the adjustable tint layer.

The head-mounted device may include one or more eye monitoring components such as gaze tracking circuitry. These components may include, for example, one or more cameras (e.g., gaze tracking cameras) and one or more light sources. The light sources may illuminate the user's eye while the camera captures an image of the eye. In an illustrative configuration, the light sources may include light-emitting diodes that create glints on the user's eye. Glint locations may be determined based on the eye images captured by the camera and may be used to determine the gaze direction of the user.

Light sources such as gaze tracking light sources and/or other light sources may be integrated into the head-mounted display. For example, the head-mounted display may have a transparent region through which the user views the environment. If desired, the transparent region may be surrounded by an opaque border region. Light sources such as gaze tracking infrared light-emitting diodes may be mounted in the transparent region of the head-mounted display. The light-emitting diodes may be mounted to a dedicated substrate in the display stack (e.g., a substrate interposed between the waveguide and the tint layer of the display), and/or the light-emitting diodes may be mounted to an existing layer in the display stack such as the tint layer. The light-emitting diodes may be sufficiently small to avoid being noticeable to the user. To convey signals between the light-emitting diodes and control circuitry, narrow traces may be used in the transparent region of the head-mounted display, while wider traces may be used in the opaque border region of the head-mounted display.

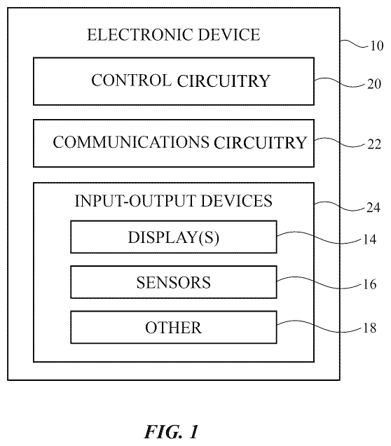

An illustrative head-mounted device that may include a transparent display with integrated light sources is shown in FIG. 1. As shown in FIG. 1, a head-mounted device such as device 10 may include control circuitry 20. Control circuitry 20 may include storage and processing circuitry for supporting the operation of device 10. The storage and processing circuitry may include storage such as nonvolatile memory (e.g., flash memory or other electrically-programmable-read-only memory configured to form a solid state drive), volatile memory (e.g., static or dynamic random-access-memory), etc. Processing circuitry in control circuitry 20 may be used to gather input from sensors and other input devices and may be used to control output devices. The processing circuitry may be based on one or more microprocessors, microcontrollers, digital signal processors, baseband processors and other wireless communications circuits, power management units, audio chips, application specific integrated circuits, etc. During operation, control circuitry 20 may use display(s) 14 and other output devices in providing a user with visual output and other output.

To support communications between device 10 and external equipment, control circuitry 20 may communicate using communications circuitry 22. Circuitry 22 may include antennas, radio-frequency transceiver circuitry, and other wireless communications circuitry and/or wired communications circuitry. Circuitry 22, which may sometimes be referred to as control circuitry and/or control and communications circuitry, may support bidirectional wireless communications between device 10 and external equipment (e.g., a companion device such as a computer, cellular telephone, or other electronic device, an accessory such as a point device, computer stylus, or other input device, speakers or other output devices, etc.) over a wireless link. For example, circuitry 22 may include radio-frequency transceiver circuitry such as wireless local area network transceiver circuitry configured to support communications over a wireless local area network link, near-field communications transceiver circuitry configured to support communications over a near-field communications link, cellular telephone transceiver circuitry configured to support communications over a cellular telephone link, or transceiver circuitry configured to support communications over any other suitable wired or wireless communications link. Wireless communications may, for example, be supported over a Bluetooth® link, a WiFi® link, a wireless link operating at a frequency between 10 GHz and 400 GHz, a 60 GHz link, or other millimeter wave link, a cellular telephone link, or other wireless communications link. Device 10 may, if desired, include power circuits for transmitting and/or receiving wired and/or wireless power and may include batteries or other energy storage devices. For example, device 10 may include a coil and rectifier to receive wireless power that is provided to circuitry in device 10.

Device 10 may include input-output devices such as devices 24. Input-output devices 24 may be used in gathering user input, in gathering information on the environment surrounding the user, and/or in providing a user with output. Devices 24 may include one or more displays such as display(s) 14. Display(s) 14 may include one or more display devices such as organic light-emitting diode display panels (panels with organic light-emitting diode pixels formed on polymer substrates or silicon substrates that contain pixel control circuitry), liquid crystal display panels, microelectromechanical systems displays (e.g., two-dimensional mirror arrays or scanning mirror display devices), display panels having pixel arrays formed from crystalline semiconductor light-emitting diode dies (sometimes referred to as microLEDs), and/or other display devices.

Sensors 16 in input-output devices 24 may include force sensors (e.g., strain gauges, capacitive force sensors, resistive force sensors, etc.), audio sensors such as microphones, touch and/or proximity sensors such as capacitive sensors such as a touch sensor that forms a button, trackpad, or other input device), and other sensors. If desired, sensors 16 may include optical sensors such as optical sensors that emit and detect light, ultrasonic sensors, optical touch sensors, optical proximity sensors, and/or other touch sensors and/or proximity sensors, monochromatic and color ambient light sensors, image sensors, fingerprint sensors, iris scanning sensors, retinal scanning sensors, and other biometric sensors, temperature sensors, sensors for measuring three-dimensional non-contact gestures (“air gestures”), pressure sensors, sensors for detecting position, orientation, and/or motion (e.g., accelerometers, magnetic sensors such as compass sensors, gyroscopes, and/or inertial measurement units that contain some or all of these sensors), health sensors such as blood oxygen sensors, heart rate sensors, blood flow sensors, and/or other health sensors, radio-frequency sensors, depth sensors (e.g., structured light sensors and/or depth sensors based on stereo imaging devices that capture three-dimensional images), optical sensors such as self-mixing sensors and light detection and ranging (lidar) sensors that gather time-of-flight measurements, humidity sensors, moisture sensors, gaze tracking sensors, electromyography sensors to sense muscle activation, facial sensors, and/or other sensors. In some arrangements, device 10 may use sensors 16 and/or other input-output devices to gather user input. For example, buttons may be used to gather button press input, touch sensors overlapping displays can be used for gathering user touch screen input, touch pads may be used in gathering touch input, microphones may be used for gathering audio input, accelerometers may be used in monitoring when a finger contacts an input surface and may therefore be used to gather finger press input, etc.

If desired, electronic device 10 may include additional components (see, e.g., other devices 18 in input-output devices 24). The additional components may include haptic output devices, actuators for moving movable housing structures, audio output devices such as speakers, light-emitting diodes for status indicators, light sources such as light-emitting diodes that illuminate portions of a housing and/or display structure, other optical output devices, and/or other circuitry for gathering input and/or providing output. Device 10 may also include a battery or other energy storage device, connector ports for supporting wired communication with ancillary equipment and for receiving wired power, and other circuitry.

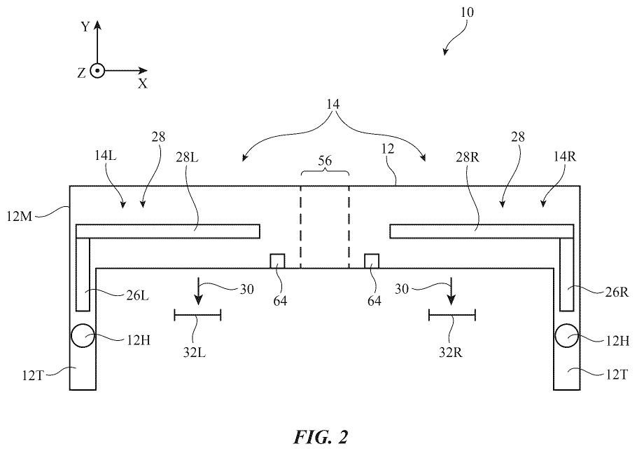

In an illustrative configuration, device 10 may be a head-mounted device such as a pair of glasses (sometimes referred to as augmented reality glasses). A top view of device 10 in an illustrative configuration in which device 10 is a pair of glasses is shown in FIG. 2. As shown in FIG. 2, device 10 may include housing 12. Housing 12 may include a main portion (sometimes referred to as a glasses frame) such as main portion 12M and temples 12T that are coupled to main portion 12M by hinges 12H. Nose bridge portion 56 of housing 12 may have a recess that allows housing 12 to rest on a nose of a user while temples 12T rest on the user's ears.

Images may be displayed in eye boxes 32L and 32R using first and second displays 14 such as left display 14L and right display 14R. Left display 14L may include left display unit 26L and left optics 28L (sometimes referred to as first display unit 26L and first optics 28L, respectively). Left optics 28L may include one or more waveguides and may sometimes be referred to as left waveguide 28L. Right display 14R may include right display unit 26R and right optics 28R (sometimes referred to as second display unit 26R and second optics 28R, respectively). Right optics 28R may include one or more waveguides and may sometimes be referred to as right waveguide 28R. Display units 26L and 26R may sometimes be referred to as projectors, projector displays, display projectors, light projectors, image projectors, light engines, or display modules. Left display unit 26L may include a left projector, and right display unit 26R may include a right projector. Left projector 26L and right projector 26R may be mounted at opposing right and left edges of main portion 12M of housing 12, for example. Projector 26L may produce a left image (sometimes referred to as a first image) that is propagated by left waveguide 28L from left temple portion 12T of housing 12 towards nose bridge portion 56 of housing 12 and viewable from left eye box 32L. Projector 26R may produce a right image (sometimes referred to as a second image) that is propagated by right waveguide 28R from right temple portion 12T of housing 12 towards nose bridge portion 56 of housing 12 and viewable from right eye box 32R.

Waveguides 28 may each include one or more stacked substrates (e.g., stacked planar and/or curved layers sometimes referred to herein as waveguide substrates) of optically transparent material such as plastic, polymer, glass, etc. If desired, waveguides 28 may also include one or more layers of holographic recording media (sometimes referred to herein as holographic media, grating media, or diffraction grating media) on which one or more diffractive gratings are recorded (e.g., holographic phase gratings, sometimes referred to herein as holograms). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating media may include photopolymers, gelatin such as dichromated gelatin, silver halides, holographic polymer dispersed liquid crystal, or other suitable holographic media.

Diffractive gratings on waveguides 28 may include holographic phase gratings such as volume holograms or thin-film holograms, meta-gratings, or any other desired diffractive grating structures. The diffractive gratings on waveguides 28 may also include surface relief gratings (SRGs) formed on one or more surfaces of the substrates in waveguides 28, gratings formed from patterns of metal structures, etc. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles). Surface relief gratings are formed from modulations in the thickness of a surface relief grating medium (e.g., where the surface relief grating includes ridges and troughs in the surface relief grating medium that form fringes of the surface relief grating). Volume holograms are formed from modulations in the refractive index in the volume of a grating medium (e.g., where lines of constant refractive index form fringes of the volume holograms).

Left and right waveguides 28L and 28R may have input couplers that receive light from respective left and right projectors 26L and 26R. This image light is then guided laterally (along the X axis of FIG. 2) within waveguides 28L and 28R in accordance with the principal of total internal reflection. In some arrangements, left and right waveguides 28L and 28R may include one or more cross-couplers that redirects light from an input coupler to an output coupler (and/or that performs pupil expansion in one or more directions). Each of waveguides 28L and 28R may have an output coupler in front of a respective one of eye boxes 32L and 32R. The output coupler couples the image light out of the waveguide and directs an image towards the associated eye box for viewing by a user (e.g., a user whose eyes are located in eye boxes 32L and 32R). Input and output couplers for device 10 may be formed from diffractive gratings (e.g., surface relief gratings, volume holograms, etc.) and/or other optical structures.

For example, as shown in FIG. 2, left projector 26L may emit (e.g., produce, generate, project, display, etc.) image light that is coupled into left waveguide 28L (e.g., by a first input coupler on left waveguide 28L). The image light may propagate in the +X direction along left waveguide 28L via total internal reflection. The output coupler on left waveguide 28L may couple the image light out of left waveguide 28L and towards left eye box 32L (e.g., for view by the user's left eye at first eye box 32L). Similarly, right projector 26R may emit (e.g., produce, generate, project, or display) image light that is coupled into right waveguide 28R (e.g., by a second input coupler on right waveguide 28R). The image light may propagate in the −X direction along right waveguide 28R via total internal reflection. The output coupler on right waveguide 28R may couple the image light out of right waveguide 28R and towards right eye box 32R (e.g., for view by the viewer's right eye at right eye box 32R).

In the arrangement of FIG. 2, waveguides 28 allow real-world light originating from outside of device 10 to be optically combined with display light from displays 14 (e.g., virtual images, computer-generated images, camera-captured images, and/or other displayed images). Real-world light may include ambient light as well as external display light generated by external displays (e.g., a cellular telephone display, a tablet computer display, or other suitable display that is viewed through device 10), whereas display light from displays 14 may originate from projectors 26L and 26R within device 10. Display light may include computer-generated display content as well as camera-captured display content. In camera-based augmented reality systems, a camera captures images of the environment and this camera-captured content is digitally merged with virtual content by device 10.

Light 30 that reaches eye boxes 32L and 32R may include only display light from respective display units 26L and 26R, may include only real-world light from the environment, or may include both display light from display units 26L and 26R and real-world light from the environment, depending on the mode in which displays 14 are operating. In this type of system, which is sometimes referred to as an augmented reality system, a user of device 10 may view both real-world content (e.g., ambient light) in the surrounding environment and display content from displays 14 that is overlaid on top of (or otherwise combined with) the real-world content.

The arrangement of FIG. 2 is merely illustrative. If desired, displays 14 may include different and/or additional optical components to allow a user to view both real-world light and display light (e.g., optical combiners formed from reflective components, diffractive components, refractive components, a direct view optical combiner, and/or other optics). These types of displays are sometimes referred to as “see-through displays.” In other arrangements, displays 14 of device 10 may be opaque instead of see-through. With an opaque display configuration, real-world content may be captured by a camera in device 10 and displayed on displays 14 (sometimes referred to as “pass-through” video). Computer-generated content (e.g., virtual images) may be overlaid on top of the real-world content or may be displayed without any real-world content. In general, device 10 may include any suitable type of binocular display with left and right displays for respective left and right eyes. Arrangements in which displays 14 are see-through displays having waveguide-based optical combiners are sometimes described herein as an example.

It may be desirable to monitor the user's eyes while the user's eyes are located in eye boxes 32L and 32R. For example, it may be desirable to use a camera to capture images of the user's irises (or other portions of the user's eyes) for user authentication. It may also be desirable to monitor the direction of the user's gaze. Gaze tracking information may be used as a form of user input and/or may be used to determine where, within an image, image content resolution should be locally enhanced in a foveated imaging system. To ensure that device 10 can capture satisfactory eye images while a user's eyes are located in eye boxes 32L and 32R, device 10 may include gaze tracking circuitry 64. Gaze tracking circuitry 64 may include one or more cameras, one or more light sources (e.g., light-emitting diodes, lasers, lamps, etc.), and/or one or more range finders for determining gaze direction and a corresponding pupil position. Device 10 may include gaze tracking circuitry 64 for each eye (e.g., a left eye and a right eye), or device 10 may include gaze tracking circuitry 64 for a single eye.

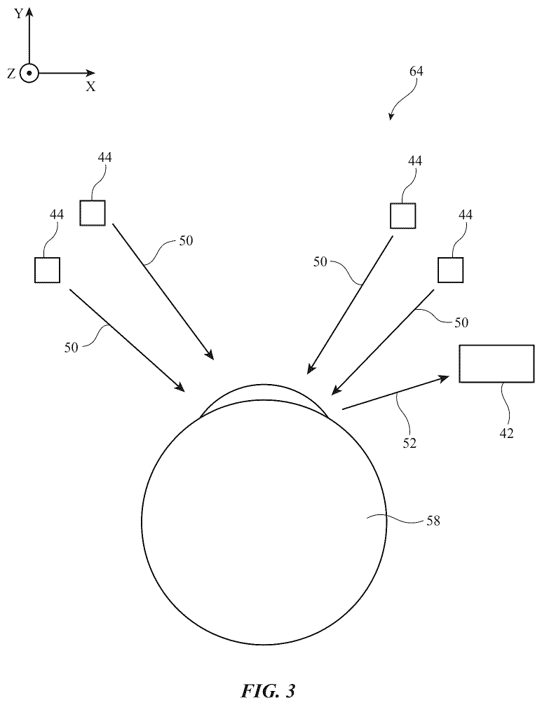

FIG. 3 is a top view of illustrative gaze tracking circuitry 64. Gaze tracking circuitry 64 may include one or more cameras such as camera 42 and one or more light sources such as light sources 44 (e.g., light-emitting diodes, lasers, lamps, etc.). Camera 42 and light-emitting diodes 44 may operate at any suitable wavelengths (visible, infrared, and/or ultraviolet). With an illustrative configuration, which may sometimes be described herein as an example, light-emitting diodes 44 emit infrared light that is invisible (or nearly invisible) to the user. This allows eye monitoring operations to be performed continuously without interfering with the user's ability to view images on displays 14.

During operation, one or more of light sources 44 may be used to emit light 50 towards eye 58. Light 50 may reflect off of eye 58 and reflected light 52 may be detected by camera 42. Emitted light 50 from light sources 44 may create one or more glints on eye 58. Camera 42 may capture images of eye 58 including the glints created by light 50. Based on the captured images, gaze tracking circuitry 64 may determine the location of the glints and the location of the user's pupil. Based on the locations of the glints produced on eye 58, gaze tracking circuitry 64 can determine the shape of the user's eye (e.g., the user's cornea), which in turn can be used to determine gaze direction.

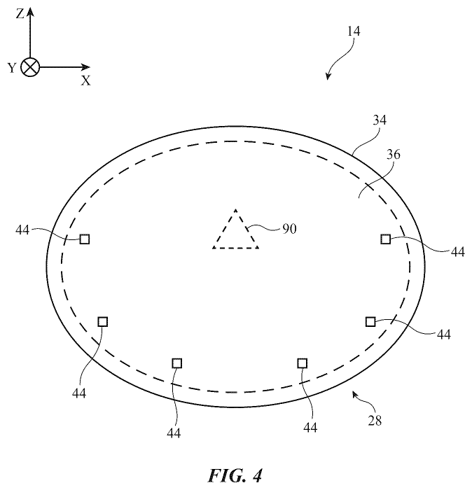

As shown in FIG. 4, one or more of light sources 44 may be integrated into display 14 to enhance eye tracking accuracy and reduce the bulkiness of device 10 around the perimeter of displays 14. Display 14 may have a transparent portion such as transparent region 36 through which the real-world environment (e.g., real-world content 90) is viewed by the user wearing device 10. Transparent region 36 of display 14 may be formed by one or more display layers such as waveguide 28 (e.g., waveguide 28L and/or waveguide 28R of FIG. 2). If desired, transparent region 36 may be surrounded by an opaque border such as opaque border region 34. Opaque border region 34 may include an opaque masking layer (e.g., black ink) and/or may include other light-blocking structures that help hide components and/or circuitry from view by a user as the user views real-world environment through transparent region 36 of display 14 (e.g., through waveguide 28 of display 14). This is merely illustrative, however. If desired, opaque border 34 may be omitted and transparent region 36 may extend the outermost edges of display 14.

Light sources 44 may be located within transparent region 36 of display 14 (e.g., overlapping a transparent portion of waveguide 28 and non-overlapping with opaque border 34), but may be sufficiently small so as to be imperceivable to a user who is viewing real-world content 90 through display 14. Light sources 44 may, for example, be micro-light-emitting diodes (e.g., having lateral dimensions of 150 microns by 75 microns, 100 microns by 50 microns, 200 microns by 100 microns, and/or any other suitable lateral dimensions). This is merely illustrative. In general, light-emitting diodes 44 may have any suitable size.

In arrangements where light-emitting diodes 44 are gaze tracking light sources that form part of gaze tracking circuitry 64, light-emitting diodes 44 may be infrared light-emitting diodes that emit infrared light towards the user's eye 58 as discussed in connection with FIG. 3. If desired, light sources 44 may be used for purposes other than gaze tracking. For example, light sources 44 may be visible light sources that emit visible light towards eye 58 and/or towards the real world (e.g., away from eye 58). Visible light sources 44 that emit light towards the user's eye may be used to create field effects (e.g., by producing a glow or other non-focused light of one or more different colors in the user's peripheral vision), whereas visible light sources 44 that emit light away from the user's eye towards the real world may be used to form visual indicators for people in front of the user wearing device 10. In some arrangements, light sources 44 may be infrared light sources that emit light towards the real world for depth sensing purposes (e.g., for facial identification purposes to authenticate a user's identity). Arrangements in which light sources 44 are gaze tracking light sources such as infrared light-emitting diodes that are used for gaze tracking purposes are sometimes described herein as an illustrative example.

Display 14 may be formed from one or more stacked layers such as waveguide 28 and one or more additional layers such as a tint layer or other light modulator layer that overlaps waveguide 28. Light-emitting diodes 44 may be mounted in transparent region 36 to any of the layers in display 14 (e.g., a tint layer) and/or to a dedicated substrate layer that is stacked with and/or laminated to waveguide 28.

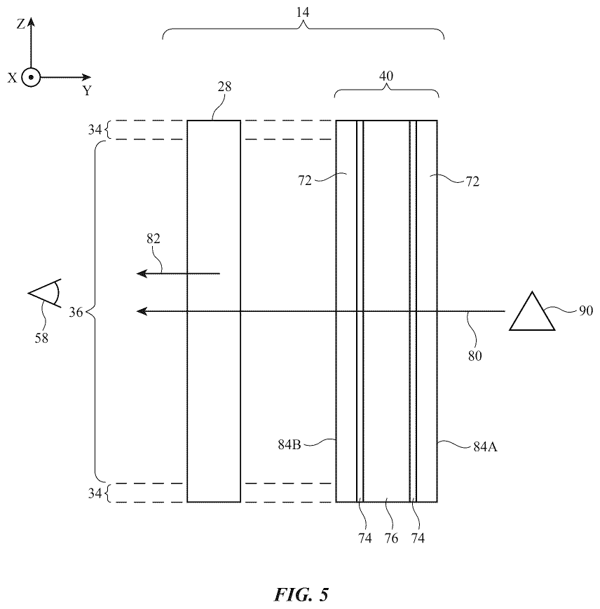

FIG. 5 is a side view of an illustrative display 14 showing an illustrative stack of display layers that may be included in device 10. As shown in FIG. 5, display 14 may include waveguide 28 and tint layer 40 overlapping waveguide 28. A user may view real-world content 90 through transparent region 36 of display 14 (e.g., transparent region 36 of waveguide 28 and tint layer 40). Tint layer 40 (sometimes referred to as a light modulator layer, an adjustable light modulator layer, an active tint layer, etc.) may be an active tint layer that is used to adjust an intensity and/or color of real-world light 80 that passes through tint layer 40. Tint layer 40 may, for example, be controlled based on ambient light conditions. An ambient light sensor may be used to measure the brightness and/or color of ambient light, and control circuitry 20 may be configured to adjust a transmissivity and/or color cast of tint layer 40 based on the measured ambient light brightness and/or ambient light color. As an example, tint layer 40 may be used to darken ambient light (e.g., real-world light 80) to improve the viewability of display light 82 (e.g., from display unit 26L and/or display unit 26R) in bright ambient light conditions.

Tint layer 40 may be a spatial light modulator formed from a liquid crystal device, may be a MEMs spatial light modulator, may be a light modulator based on a cholesteric liquid crystal layer, may be a light modulator based on a switchable metal hydride film (e.g., an adjustable magnesium hydride mirror structure), may be a suspended particle device, may be an electrochromic light modulating device, may be a guest-host liquid crystal light modulator, or may be any other suitable light modulator layer for adjusting light transmission. Tint layer 40 may have blanket electrodes that control the entirety of tint layer 40 in a uniform fashion, or tint layer 40 may have an array of electrodes or other structures that allow individually adjustable light modulator regions (sometimes referred to as light modulator pixels) to be adjusted between a transparent state (transmission is 100% or nearly 100%) and an opaque state (transmission is 0% or nearly 0%). Intermediate levels of light transmission (e.g., transmission values between 0% and 100%) may also be selectively produced by each of the pixels of tint layer 40.

If desired, tint layer 40 may be configured to adjust the color of real-world light 80 that passes through tint layer 40. For example, tint layer 40 may be an adjustable-color-cast light filter that can be adjusted to exhibit different color casts and/or may be a monochromatic adjustable-intensity light filter that has a single (monochromatic) color cast. For example, in one state, tint layer 40 may be clear and may not impose any color cast onto light passing through tint layer 40. In another state, tint layer 40 may be yellow. In yet another state, tint layer 40 may be pink. If desired, tint layer 40 may have a monochromatic appearance (e.g., tint layer 40 may be a monochromatic adjustable light filter such as a yellow adjustable light filter that can be adjusted continuously or in a stepwise fashion to exhibit appearances that range from clear to light yellow to strongly yellow). The color and/or intensity (saturation) of tint layer 40 may be adjusted continuously (e.g., to any color in a desired color space and/or any strength) or may be set to one of a more restricted group different available colors or range of colors and/or color saturation levels. Tint layer 40 may be formed from devices such as a liquid crystal device (e.g., an interference filter with a liquid crystal layer that has an electrically adjustable index of refraction), a phase-change layer based on a chalcogenide material or other materials that can be adjusted to selectively adjust color cast, a guest-host liquid crystal device or other device with an absorption spectrum that can be electrically controlled, an electrooptic device, an electrochromic layer, or any other device that exhibits a tunable color (adjustable color cast) as a function of applied control signals. Adjustable tint layer 40 may have blanket electrodes or may include an array of electrodes (e.g., an array of individually addressable electrodes) or other structures that allow individual regions of tint layer 40 to be adjusted.

As shown in FIG. 5, tint layer 40 may include a layer of liquid crystal material such as liquid crystal layer 76 (e.g., a cholesteric liquid crystal layer, a guest-host liquid crystal layer, a polymer-dispersed liquid crystal layer, a twisted nematic crystal layer, and/or any other suitable crystal layer or light modulating layer). Layer 76 may be sandwiched between opposing electrodes such as electrodes 74. If desired, electrodes such as electrodes 74 may be patterned in lateral dimensions X and Z to form a desired pattern of individually adjustable tint layer pixels, or electrodes 74 may be blanket electrodes that adjust the entirety of layer 76 in a uniform fashion. Electrodes 74 may be formed from indium tin oxide, silver nanowires, and/or any other suitable transparent conductive material. Electrodes 74 may be supported by respective transparent substrates such as first and second substrates 72. Substrates 72 may be formed from transparent glass, transparent polymer, or other transparent materials. Control circuitry 20 may use tint layer 40 to adjust the intensity and/or color of real-world light 80 that passes from real-world-facing surface 84A of tint layer 40 to user-facing surface 84B of tint layer 40 by applying appropriate control signals to electrodes 74.

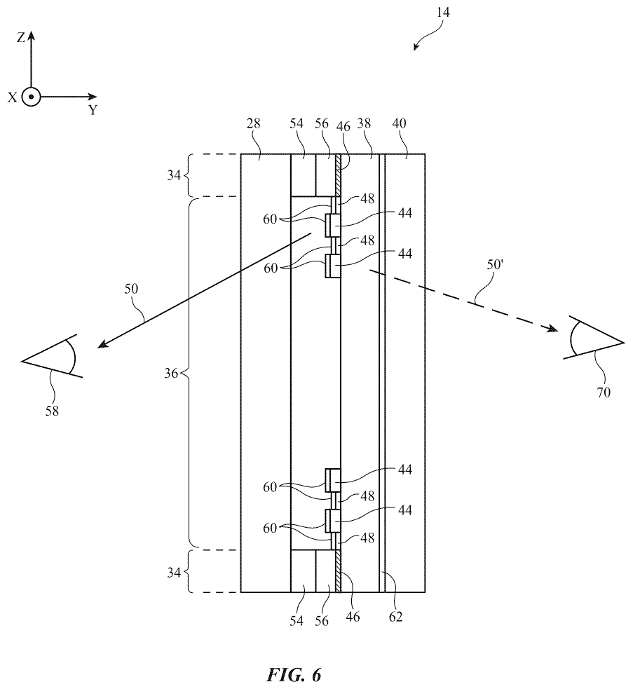

In the example of FIG. 6, light-emitting diodes 44 are mounted to a substrate interposed between tint layer 40 and waveguide 28. For example, light-emitting diodes 44 may be mounted to a substrate such as transparent substrate 38. Transparent substrate 38 (sometimes referred to as emitter layer 38) may be formed from transparent glass, transparent polymer, or other transparent materials. If desired, transparent substrate 38 may be laminated to tint layer 40 using adhesive layer 62 (e.g., an optically clear adhesive) and may be laminated to waveguide 28 using adhesive layer 56. In the example of FIG. 6, adhesive layer 62 is a blanket layer of adhesive that extends across transparent region 36 and opaque region 34. This is merely illustrative. If desired, adhesive layer 62 may be a peripheral adhesive border located only in opaque border 34 and having an aperture overlapping transparent region 36. Adhesive layer 56 is located in opaque border 34 and forms a border around transparent region 36. If desired, adhesive layer 56 may be a blanket layer of transparent adhesive that extends across transparent region 36. The arrangement of FIG. 6 is merely illustrative.

Light-emitting diodes 44 may be mounted within transparent region 36 of display 14 and may be configured to emit light 50 towards eye 58 to create glints for gaze tracking purposes, as discussed in connection with FIG. 3. Control circuitry 20 may provide control signals and/or other electrical signals to light-emitting diodes 44 via traces such as trace portions 48 and trace portions 46. Traces 48 (sometimes referred to as first portions or segments of the traces) are located within transparent region 36, whereas traces 46 (sometimes referred to as second portions or segments of the traces) are located in opaque border region 34. If desired, traces 48 may be narrower than traces 46 and/or may be formed from a different material than traces 46 to avoid being perceivable to a user. For example, traces 48 may be thin and narrow copper traces, metal nanowires (e.g., copper nanowires, silver nanowires, etc.), indium tin oxide, and/or other narrow conductive traces. Traces 46 may be wider and/or thicker than traces 48 and may be formed from metal lines on substrate 38 (e.g., copper, silver, etc.).

To avoid being noticeable to a user, one or both sides of light-emitting diodes 44 and/or traces 48 in clear aperture 36 may be coated or otherwise covered with a matte layer such as matte coating 60, if desired. Perimeter traces 46 may be hidden from view using an opaque masking material such as opaque masking material 54 (e.g., black ink) in opaque border 34. In the example of FIG. 6, opaque masking material 54 is interposed between adhesive 56 and waveguide 28. This is merely illustrative. If desired, adhesive 56 may be interposed between opaque masking material 54 and waveguide 28.

Light-emitting diodes 44 may be used to emit light 50 towards a user's eye 58 and/or may be used to emit light 50′ away from eye 58 towards the real world (e.g., towards eye 70 of a person in front of the user wearing device 10). Light 50 may be infrared light used for gaze tracking purposes (as discussed in connection with FIG. 3), or light 50 may be visible light for creating glow effects or other non-focused field effects in the user's peripheral vision. Light 50′ may be visible light for forming a visual indicator for eye 70, or light 50′ may be infrared light for performing depth sensing operations, user authentication operations (e.g., facial identification operations), and/or other operations. If desired, tint layer 40 may include infrared-light-passing apertures that allow light 50′ to reach eye 70. This is merely illustrative. If desired, light sources 44 may only emit light in a single direction (e.g., towards eye 58 for gaze tracking purposes).

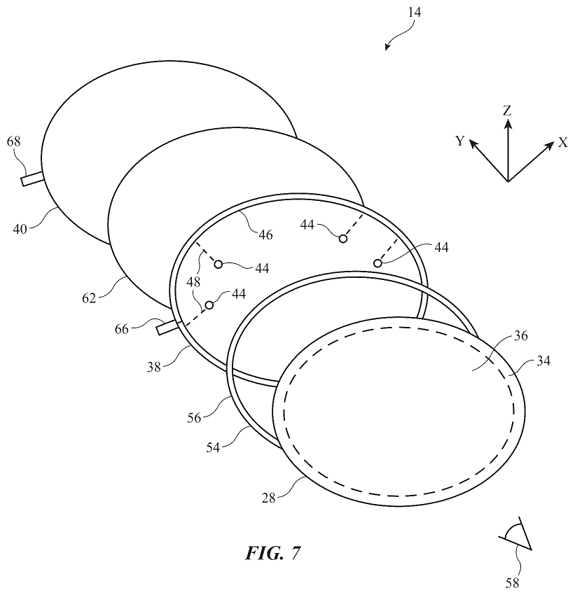

FIG. 7 is an exploded perspective view of display 14 of FIG. 6. As shown in FIG. 7, a printed circuit such as flexible printed circuit 68 may be coupled to tint layer 40. Control circuitry 20 may provide control signals and/or other electrical signals to tint layer 40 through flexible printed circuit 68. A printed circuit such as flexible printed circuit 66 may be coupled to substrate 38 and may be used to provide control signals and/or other electrical signals from control circuitry 20 to light sources 44 (e.g., via traces 46 and 48 on substrate 38). If desired, flexible printed circuit 68 of tint layer 40 may be hot bar laminated or otherwise electrically coupled to flexible printed circuit 66 of emitter layer 38 to help reduce electrical connections to display 14. This is merely illustrative. If desired, flexible printed circuit 68 and flexible printed circuit 66 may not be electrically connected to one another and may instead form independent electrical paths between control circuitry 20 and display 14.

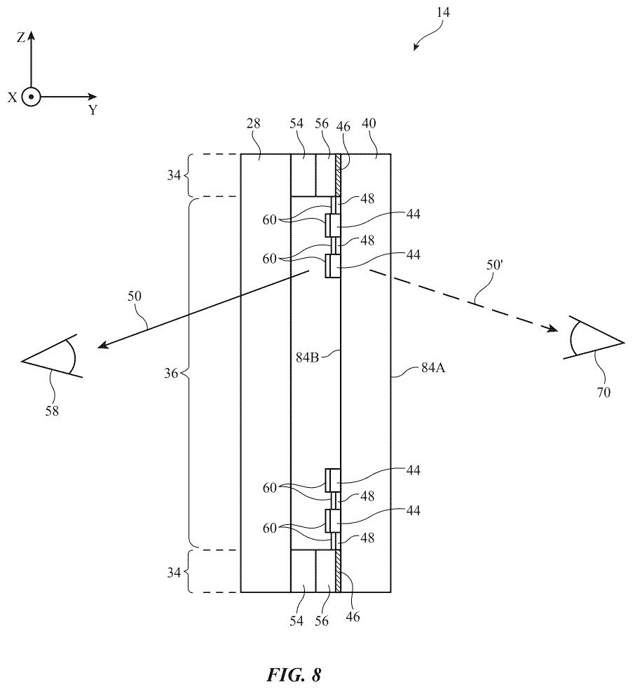

The examples of FIGS. 6 and 7 in which light sources 44 are mounted to a dedicated emitter layer such as substrate 38 are merely illustrative. If desired, light sources 44 may be mounted to a layer of display 14 such as tint layer 40. This type of arrangement is illustrated in FIG. 8.

As shown in FIG. 8, light-emitting diodes 44 are mounted to user-facing surface 84B of tint layer 40 (e.g., user-facing surface 84B of substrate 72 of FIG. 5) and are interposed between tint layer 40 and waveguide 28. If desired, tint layer 40 may be laminated to waveguide 28 using adhesive layer 56. Adhesive layer 56 is located in opaque border 34 and forms a border around transparent region 36. If desired, adhesive layer 56 may be a blanket layer of transparent adhesive that extends across transparent region 36. The arrangement of FIG. 8 is merely illustrative.

Light-emitting diodes 44 may be mounted within transparent region 36 of display 14 and may be configured to emit light 50 towards eye 58 to create glints for gaze tracking purposes, as discussed in connection with FIG. 3. Control circuitry 20 may provide control signals and/or other electrical signals to light-emitting diodes 44 via traces such as trace portions 48 and trace portions 46. Traces 48 (sometimes referred to as first portions or segments of the traces) are located within transparent region 36, whereas traces 46 (sometimes referred to as second portions or segments of the traces) are located in opaque border region 34. If desired, traces 48 may be narrower than traces 46 and/or may be formed from a different material than traces 46 to avoid being perceivable to a user. For example, traces 48 may be thin and narrow copper traces, metal nanowires (e.g., copper nanowires, silver nanowires, etc.), indium tin oxide, and/or other narrow conductive traces. Traces 46 may be wider and/or thicker than traces 48 and may be formed from metal lines on user-facing surface 84B of tint layer 40 (e.g., copper, silver, etc.).

To avoid being noticeable to a user, one or both sides of light-emitting diodes 44 and/or traces 48 in clear aperture 36 may be coated or otherwise covered with a matte layer such as matte coating 60, if desired. Perimeter traces 46 may be hidden from view using an opaque masking material such as opaque masking material 54 (e.g., black ink) in opaque border 34. In the example of FIG. 8, opaque masking material 54 is interposed between adhesive 56 and waveguide 28. This is merely illustrative. If desired, adhesive 56 may be interposed between opaque masking material 54 and waveguide 28.

Light-emitting diodes 44 may be used to emit light 50 towards a user's eye 58 and/or may be used to emit light 50′ away from eye 58 towards the real world (e.g., towards eye 70 of a person in front of the user wearing device 10). Light 50 may be infrared light used for gaze tracking purposes (as discussed in connection with FIG. 3), or light 50 may be visible light for creating glow effects or other non-focused field effects in the user's peripheral vision. Light 50′ may be visible light for forming a visual indicator for eye 70, or light 50′ may be infrared light for performing depth sensing operations, user authentication operations (e.g., facial identification operations), and/or other operations. If desired, tint layer 40 may include infrared-light-passing apertures that allow light 50′ to reach eye 70. This is merely illustrative. If desired, light sources 44 may only emit light in a single direction (e.g., towards eye 58 for gaze tracking purposes).

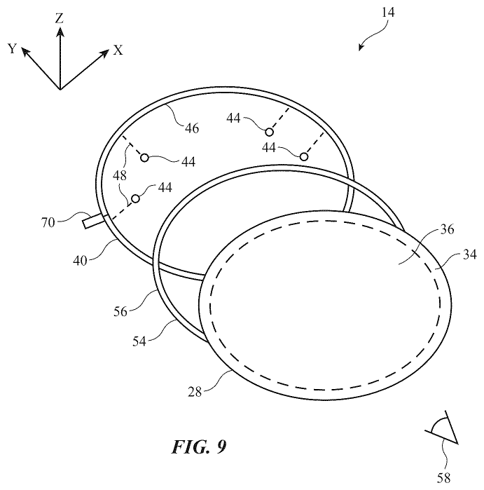

FIG. 9 is an exploded perspective view of display 14 of FIG. 8. As shown in FIG. 9, a printed circuit such as flexible printed circuit 70 may be coupled to tint layer 40. Control circuitry 20 may provide control signals and/or other electrical signals to tint layer 40 through flexible printed circuit 68. If desired, flexible printed circuit 70 may also be used to provide control signals and/or other electrical signals from control circuitry 20 to light sources 44 on tint layer 40 (e.g., via traces 46 and 48 on tint layer 40) to help reduce electrical connections to display 14. This is merely illustrative. If desired, separate printed circuits may be coupled to tint layer 40 to provide signals to tint layer 40 and light sources 44, respectively.

The foregoing is merely illustrative and various modifications can be made to the described embodiments. The foregoing embodiments may be implemented individually or in any combination.

What is claimed is:

1. A head-mounted display having a transparent region through which a real-world environment is viewable from an eye box, the head-mounted display comprising:
a projector configured to produce display light;
a waveguide configured to provide the display light to the eye box;
a light modulator layer overlapping the waveguide; and
a light source interposed between the light modulator layer and the waveguide, wherein the light source is located within the transparent region of the head-mounted display.

2. The head-mounted display defined in claim 1 wherein the light source is mounted to a transparent substrate interposed between the waveguide and the light modulator layer.

3. The head-mounted display defined in claim 2 further comprising:
a first printed circuit coupled to the transparent substrate and a second printed circuit coupled to the light modulator layer.

4. The head-mounted display defined in claim 3 wherein the first and second printed circuits are hot bar laminated to each other.

5. The head-mounted display defined in claim 3 further comprising a conductive trace on the transparent substrate that is configured to convey electrical signals between the first printed circuit and the light source, wherein the conductive trace has a first portion in the transparent region of the head-mounted display and a second portion that is hidden by an opaque masking layer.

6. The head-mounted display defined in claim 5 wherein the second portion of the conductive trace is wider than the first portion of the conductive trace.

7. The head-mounted display defined in claim 1 wherein the light source is mounted to the light modulator layer.

8. The head-mounted display defined in claim 7 further comprising a printed circuit coupled to the light modulator layer.

9. The head-mounted display defined in claim 8 further comprising a conductive trace on the light modulator layer that is configured to convey electrical signals between the printed circuit and the light source, wherein the conductive trace has a first portion in the transparent region of the head-mounted display and a second portion that is hidden by an opaque masking layer.

10. The head-mounted display defined in claim 9 wherein the second portion of the conductive trace is wider than the first portion of the conductive trace.

11. The head-mounted display defined in claim 9 further comprising a matte coating that covers at least one of the light source and the first portion of the conductive trace.

12. The head-mounted display defined in claim 1 wherein the light source comprises a gaze tracking infrared light-emitting diode.

13. A head-mounted display having a transparent region through which a real-world environment is viewable from an eye box, the head-mounted display comprising:
a projector configured to produce display light;
a waveguide configured to provide the display light to the eye box;
a transparent substrate overlapping and coupled to the waveguide; and
a gaze tracking light source mounted to the transparent substrate within the transparent region of the head-mounted display.

14. The head-mounted display defined in claim 13 further comprising an active tint layer overlapping the waveguide, wherein the transparent substrate is interposed between the active tint layer and the waveguide.

15. The head-mounted display defined in claim 14 wherein the active tint layer, the transparent substrate, and the waveguide are laminated together.

16. The head-mounted display defined in claim 13 wherein the transparent substrate forms part of a light modulator layer.

17. A head-mounted display having a transparent region, the head-mounted display comprising:
a waveguide;
a tint layer overlapping and coupled to the waveguide; and
a gaze tracking light-emitting diode interposed between the waveguide and the tint layer and located within the transparent region of the head-mounted display.

18. The head-mounted display defined in claim 17 wherein the tint layer comprises an active tint layer configured to adjust at least one of intensity and color of light that is transmitted by the active tint layer.

19. The head-mounted display defined in claim 18 wherein the tint layer comprises first and second transparent substrates and wherein the gaze tracking light-emitting diode is mounted to the first substrate.

20. The head-mounted display defined in claim 18 wherein the gaze tracking light-emitting diode is mounted to a transparent substrate that is interposed between and laminated to the waveguide and the tint layer.
